(19) United States
(12) Patent Application Publication
(10) Pub. No.: US 2017/0124556 A1
(43) Pub. Date: May 4, 2017

(54) EVENT SYNCHRONIZATION SYSTEMS AND METHODS

(71) Applicant: MANIFOLD TECHNOLOGY, INC., MENLO PARK, CA (US)

(72) Inventor: Robert Allan SEGER, II, San Jose, CA (US)

(73) Assignee: MANIFOLD TECHNOLOGY, INC., MENLO PARK, CA (US)

(21) Appl. No.: 15/266,651

(22) Filed: Sep. 15, 2016

Related U.S. Application Data
(60) Provisional application No. 62/253,460, filed on Nov. 10, 2015.
(60) Provisional application No. 62/244,376, filed on Oct. 21, 2015.

(51) Int. Cl. G06Q 20/38; G06Q 30/02

(52) U.S. Cl. CPC G06Q 20/3829; G06Q 30/0233; H04L 67/10

(57) ABSTRACT

A distributed event synchronization may be provided by a plurality of nodes in communication with one another via a network. An event module of one of the plurality of nodes may receive data about an event to be codified in a distributed ledger. The event module may place the event in an event queue for distributed block negotiation. A ledger module of the one of the plurality of nodes may perform the block negotiation with at least one other node in the network. Performing the block negotiation may comprise sharing the event queue; determining a greatest common set of shared events comprising the event; when a consensus quorum of the plurality of nodes has determined the greatest common set, creating a block comprising the greatest common set of shared events; sharing local data relating to the block; receiving additional data relating to the block from the at least one other node; and when the local data and the additional data agree, writing the block into a distributed ledger shared by the memory of each of the plurality of nodes.

### CROSS REFERENCE TO RELATED APPLICATIONS

This application claims priority to U.S. Provisional Application Ser. No. 62/253,460, filed Nov. 10, 2015 and U.S. Provisional Application Ser. No. 62/244,376, filed Oct. 21, 2015. The entirety of all the above-listed applications are incorporated herein by reference.

### BRIEF DESCRIPTION OF THE DRAWINGS

FIG. 1 illustrates a cryptographic information exchange system according to an embodiment of the invention.

FIG. 2 illustrates a cryptographic information exchange method according to an embodiment of the invention.

FIG. 3 illustrates a cryptographic information exchange method according to an embodiment of the invention.

FIG. 4 illustrates an event synchronization network according to an embodiment of the invention.

FIG. 5 illustrates an event synchronization method according to an embodiment of the invention.

FIG. 6 illustrates a consensus protocol method according to an embodiment of the invention.

FIG. 7 illustrates a rewards exchange method according to an embodiment of the invention.

FIG. 8 illustrates a rewards earning method according to an embodiment of the invention.

FIG. 9 illustrates a rewards synchronization method according to an embodiment of the invention.

### DETAILED DESCRIPTION OF SEVERAL EMBODIMENTS

Systems and methods described herein may provide a cryptographic platform for recording transaction information and/or a platform for event synchronization among multiple nodes. Example embodiments may retrieve and/or provide one or more events to a distributed ledger. Throughout the description, transactions (e.g., single financial transactions or complex legal contracts) are used as examples of events that may be synchronized by the disclosed systems and methods. However, any type of event may be handled. There may be no limit to the number of characteristics that may comprise a single event, therefore event recorded in the distributed ledger may be complex event records.

Example events may be transactions including encrypted information intended for a given party. The encrypted information may be encrypted with the intended party's public key such that a private key associated with the intended party is required to decrypt the encrypted information. The encrypted information may be decrypted with an associated private key and displayed to the intended recipient. Information transactions including second information encrypted by the intended recipient's public key may be generated and provided to the distributed ledger. As such, the cryptographic platform may provide confidential, verifiable, and immutable recording and/or reporting of information transactions including encrypted information (e.g., private communications) that may be audited by a third party.

In some embodiments, providing an event synchronization platform may be performed by computers and/or processors executing computer program modules. A computer may be any programmable machine or machines capable of performing arithmetic and/or logical operations. In some embodiments, computers may comprise processors, memories, data storage devices, and/or other commonly known or novel modules. These modules may be connected physically or through network or wireless links. Computers may also comprise software which may direct the operations of the aforementioned modules. Computers may be referred to with terms that are commonly used by those of ordinary skill in the relevant arts, such as servers, PCs, mobile devices, routers, switches, data centers, distributed computers, and other terms. Computers may facilitate communications between users and/or other computers, may provide databases, may perform analysis and/or transformation of data, and/or perform other functions. It will be understood by those of ordinary skill that those terms used herein are interchangeable, and any computer capable of performing the described functions may be used.

Computers may be linked to one another via a network or networks. A network may be any plurality of completely or partially interconnected computers wherein some or all of the computers are able to communicate with one another. It will be understood by those of ordinary skill that connections between computers may be wired in some cases (e.g., via Ethernet, coaxial, optical, or other wired connection) or may be wireless (e.g., via Wi-Fi, WiMax, 4G, or other wireless connections). Connections between computers may use any protocols, including connection-oriented protocols such as TCP or connectionless protocols such as UDP. Any connection through which at least two computers may exchange data can be the basis of a network.

In some embodiments, the computers used in the described systems and methods may be special purpose computers configured specifically to provide event synchronization. For example, a device may be equipped with specialized processors, memory, communication modules, etc. that are configured to perform the functions described herein.

### Cryptographic Data Exchange

Systems and methods described herein may provide a cryptographic platform for exchanging information. Example embodiments may retrieve and/or provide one or more information transactions to a distributed ledger. The information transactions may include encrypted information intended for a given party. The encrypted information may be encrypted with the intended party's public key such that a private key associated with the intended party may be required to decrypt the encrypted information. The encrypted information may be decrypted with an associated private key such that it may be displayed to the intended recipient. Information transactions including a second information encrypted by the intended recipient's public key may be generated and provided to the distributed ledger. As such, in some embodiments, the cryptographic platform may facilitate secure private communication between multiple parties via information transactions provided and retrieved from a distributed ledger. Furthermore, the cryptographic platform may enable confidential, verifiable, and immutable recording and/or reporting of information transactions including various encrypted information (e.g., private communications) that may be audited by a third party.

In some embodiments, the system may include one or more servers. The servers may be configured to communicate with one or more client computing platforms according to a client/server architecture. The parties may access the system via client computing platforms.

In some embodiments, the systems and/or methods for providing a cryptographic platform for exchanging information as described herein may be used as a means of exchange from one to many and/or many to one (e.g., from one party to multiple parties and/or from multiple parties to one party). In some embodiments, the parties may include one or more of multiple end parties, multiple sub-parties of a single party (e.g., to facilitate exchange of information internally and/or among subordinate entities), and/or other parties.

In some embodiments, the system may include a key module, an identification module, a retrieval module, an information module, an encryption module, a decryption module, a transaction module, a ledger module, and/or other modules. These modules may comprise special-purpose hardware and/or software operating on a processor.

In some embodiments, the key module may be configured to provide a first public key associated with a first party to a second party. The first public key may be provided to the second party to enable information intended for the first party to be encrypted with the first public key. In some embodiments, the key module may be configured to obtain a second public key associated with a second party.

The identification module may be configured to identify a first information transaction. The first information transaction may include information intended for the first party. One or more information transactions, including the first information transaction, may be held within a distributed ledger. The distributed ledger may provide a verifiable record of one or more information transactions. The first information transaction may include one or more of: a first information transaction identifier associated with the first party; a first information payload; and/or other information. The first information payload may include first encrypted information. The first encrypted information may be encrypted with a first public key associated with the first party. In some embodiments, the first information transaction identifier may not be encrypted. In some embodiments, the first information transaction identifier may include the first public key.

In some embodiments, the identification module may be configured to identify a second party as a source of the first information transaction. In some embodiments, the identification module may be configured to identify one or more information transactions included in an audit.

The retrieval module may be configured to retrieve the first information transaction from the distributed ledger. The distributed ledger may provide a verifiable record of various information transactions including various information payloads that may include various encrypted information that may be encrypted with various public keys. In some embodiments, the retrieval module may be configured to retrieve one or more of information describing the one or more information transactions determined to be included in the audit, information payloads included in the one or more information transactions determined to be included in the audit, the one or more information transactions determined to be included in the audit, and/or other information related to an audit.

The decryption module may be configured to decrypt the first encrypted information with a first private key that corresponds to the first public key. The presentation module may be configured to facilitate presentation of the first encrypted information through an electronic display to the first party.

In some embodiments, the information module may receive second information from the first party. The second information may include a communication for the second party (e.g., a response to the first encrypted information).

In some embodiments, the encryption module may be configured to encrypt the second information with a second public key associated with the second party. In some embodiments, the encryption module may be configured to encrypt the second information with a third public key associated with a third party. As such, a second private key and a third private key may be required to decrypt the second encrypted information.

In some embodiments, the first encrypted information may include a request for information. The second encrypted information may include information requested in the request for information. The first encrypted information and/or the second encrypted information may include one or more of a message, an image, a document, a video, and/or other types of content. For example, the first encrypted information and/or the second encrypted information may include one or more of know your customer (KYC) data; anti-money laundering (AML) data; and/or other financial data.

The systems and methods for providing a cryptographic platform for exchanging information as described herein may be used for various applications and the disclosure and examples provided are not intended to be limiting. In some embodiments, for example, the various applications may include: exchange of financial information; managing rewards points; storing and exchanging transaction-specific payment tokens; facilitating remittance services; reconciling accounts across disparate entities (e.g., subsidiaries and/or partners); consolidating discrete business unit ledgers; replacing legacy core settlement systems; transferring health care information; and/or other applications.

In some embodiments, the transaction module may be configured to generate a second information transaction. The second information transaction may include one or more of a second information transaction identifier associated with the second party; a second information payload; and/or other information. The second information payload may include second encrypted information. In some embodiments, the second encrypted information included in the second payload may include a first portion and a second portion. The first portion may be encrypted with the second public key associated with the second party. The second portion may be encrypted with a third public key associated with a third party. In some embodiments, the second portion may be encrypted with the third public key.

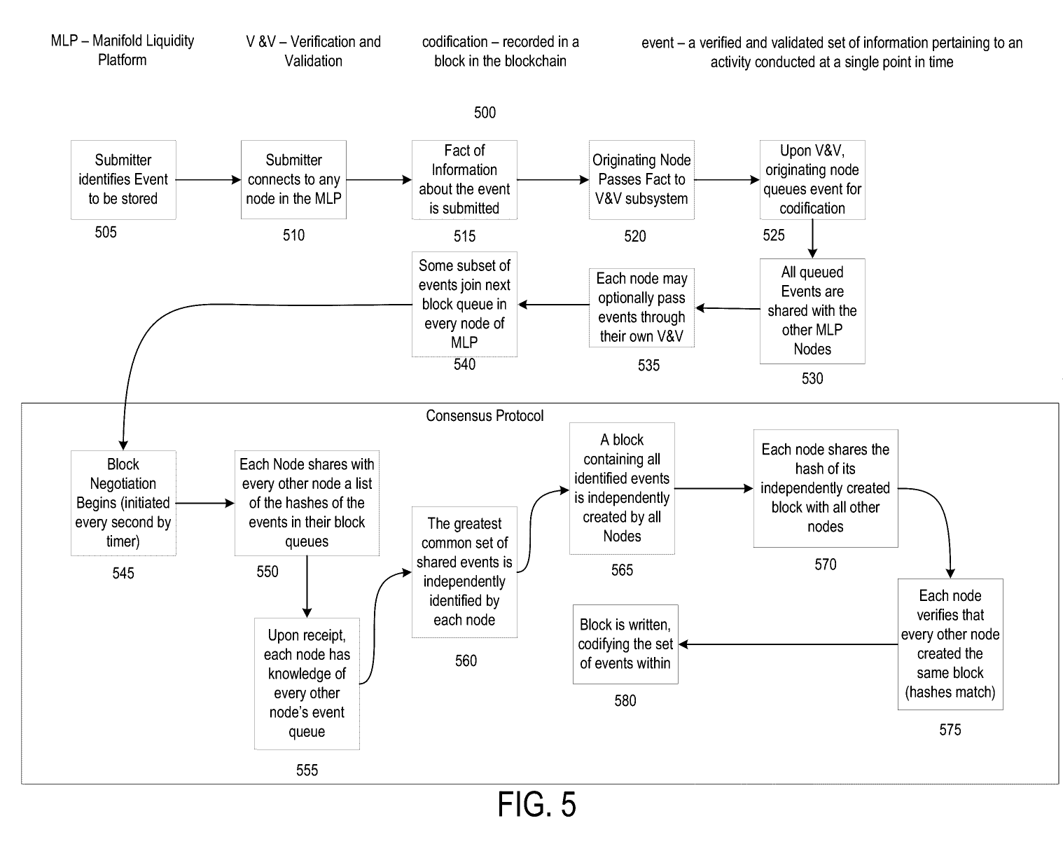

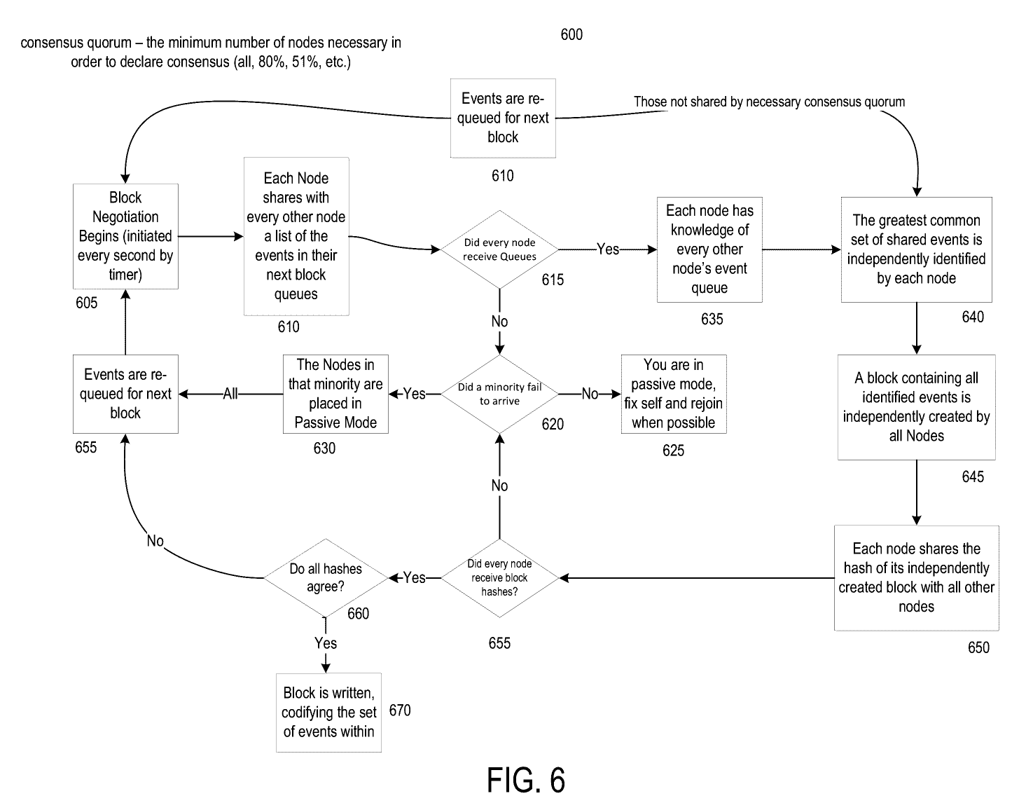

In some embodiments, the ledger module may be configured to provide the second information transaction, including the second information payload, to the distributed ledger. In some embodiments, the ledger module may be configured to interface with a public distributed ledger platform (e.g., a Ripple® ledger). In some embodiments, the ledger module may be configured to manage a private distributed ledger according to a custom consensus protocol (e.g., as described in greater detail below with respect to FIGS. 5-6). Managing the distributed ledger may include implementing the custom consensus protocol to create verified instances of the distributed ledger.

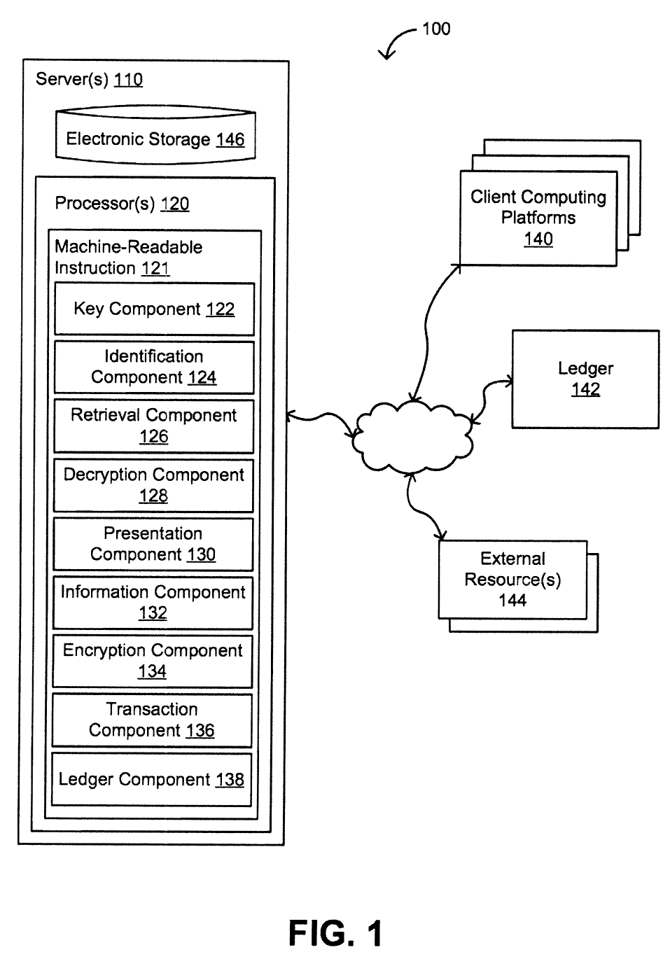

FIG. 1 illustrates a system 100 configured for providing a cryptographic platform for exchanging information, in accordance with one or more embodiments. System 100 may be configured to identify a first information transaction. The first information transaction may include information intended for a first party. One or more information transactions, including the first information transaction, may be held within a distributed ledger. The first information transaction may include one or more of a first information transaction identifier associated with the first party, a first information payload, and/or other information. The first information payload may include first encrypted information. The first encrypted information may be encrypted with a first public key associated with the first party. System 100 may be configured to retrieve the first information transaction from the distributed ledger. As such, in example embodiments, the distributed ledger may provide a verifiable record of various information transactions, including various information payloads that include various encrypted information that is encrypted with various public keys. System 100 may decrypt the first encrypted information with a first private key that corresponds to the first public key. Presentation of the first encrypted information to the first party may be facilitated by system 100 through an electronic display.

System 100 may include one or more servers 110. Servers 110 may be configured to communicate with client computing platforms 140 according to a client/server architecture. A user and/or one or more given parties may access system 100 via client computing platforms 140. In some embodiments, ledger 142 may include a distributed ledger managed by an external system. Servers 110 may be configured to communicate with ledger 142 according to a peer-to-peer architecture, client/server architecture, server/server architecture, and/or other architectures. Communicating with ledger 142 may include communicating with one or more additional servers (e.g., participants of the distributed ledger).

The servers 110 may comprise one or more modules 121. Modules 121 may include one or more of a key module 122, an identification module 124, a retrieval module 126, a decryption module 128, a presentation module 130, an information module 132, an encryption module 134, a transaction module 136, a ledger module 138, and/or other modules.

System 100 may implement one or more forms of public key, or asymmetric, cryptography to facilitate communication through the distributed ledger. Key module 122 may be configured to provide one or more public keys associated with a given party to one or more parties having a desire to communicate with the given party. In some embodiments, key module 122 may be configured to store public keys associated with one or more parties. The concept of being associated with a given party may include the concept of being unique to and/or belonging to the given party. For example, a public key associated with the given party may correspond to a private key held by the given party. In some embodiments, key module 122 may be configured to obtain one or more public keys associated with one or more parties. A given public key associated with a given party may be obtained for encrypting information intended for (e.g., to be received by) the given party.

In some embodiments, key module 122 may be configured to store one or more private keys corresponding to various public keys associated with one or more parties. Key module 122 may be configured to obtain a given private key associated with a given party in order to decrypt information encrypted with a given corresponding public key that was intended for (e.g., received by) the given party. In some embodiments, key module 122 may be configured to securely store, obtain, and/or provide one or both of public keys or private keys associated with one or more parties such that information included in a given payload that is included in a given information transaction may be encrypted and/or decrypted. Additional security measures may be enabled by system 100 and/or key module 122 to ensure that access to the private keys and/or to the information decrypted by the private keys is limited to system 100 and the parties associated with the private keys. In some embodiments, one or more private keys may be held and/or generated by one or more third parties. Thus, in some embodiments, the private keys may be provided to system 100 (e.g., key module 122) by the one or more parties for individual decryption instances.

For example, key module 122 may provide a first public key associated with a first party to a second party such that information intended for the first party may be encrypted with the first public key. In another example, key module 122 may obtain a second public key associated with the second party such that information (e.g., a response) intended for the second party may be encrypted with the second public key.

Identification module 124 may be configured to identify one or more information transactions that may be held within a distributed ledger. The information transactions may include information intended for one or more given parties. The distributed ledger may provide a verifiable record of one or more information transactions. In some embodiments, the distributed ledger may include one or more of a public ledger, a blockchain, a consensus ledger, a distributed database, and/or another verified record log. In some embodiments, the distributed ledger may include a public distributed ledger. For example, the public distributed ledger may include a Ripple® ledger. In some embodiments, the distributed ledger may include a private distributed ledger provided and/or managed by system 100.

Identifying one or more transactions that may be held within the distributed ledger may include one or more of communicating with one or more third-party servers configured to monitor the distributed ledger and/or to identify one or more information transactions; monitoring the distributed ledger; polling the distributed ledger; reviewing a list of information transactions in the distributed ledger (e.g., produced by some third party); receiving an indication, such as a separate electronic message or other indication, from a party who has entered an information transaction to the distributed ledger; pulling one or more information transactions; flagging one or more information transactions; filtering one or more information transactions; requiring that the intended party participate in the initial generation of the information transaction/recording of the information (e.g., requiring that the intended party cryptographically sign the message for it be entered into the ledger), reviewing transactions in otherwise agreed upon windows of time (e.g., parties negotiate that their messages will be spaced, via some mathematical distribution, every X milliseconds into the ledger), and/or other methods of identifying one or more transactions. In some embodiments, the transactions may be identified based on the transaction identifier.

Identification module 124 may be configured to identify a first information transaction that may be held within the distributed ledger. The first information transaction may include information intended for the first party. For example, the information intended for the first party may include one or more of a message, an image, a document, a video, and/or other types of content. In this example, the information may include and/or be associated with one or more of know your customer (KYC) data; anti-money laundering (AML) data; and/or other financial data.

The first information transaction may include one or more of: a first information transaction identifier associated with the first party; a first information payload; and/or other information. The first information payload may include first encrypted information. The first encrypted information may be encrypted with a first public key associated with the first party. The first encrypted information may include one or more types of content, such as a message, an image, a document, a video, and/or other types of content. In some embodiments, the first encrypted information may include and/or be associated with one or more of know your customer (KYC) data; anti-money laundering (AML) data; and/or other financial data.

In some embodiments, the first encrypted information may include a request for information. In some embodiments, the first encrypted information may include information provided in response to a communication and/or request received via one or more other avenues (e.g., besides the distributed ledger). For example, one or more other avenues may include email, website communications, short messaging service (SMS), and/or other communication methods.

In some embodiments, the first information transaction identifier included in the first information transaction may not be encrypted. As such, for example, identification module 124 may not be required to read through the entire contents of the first information transaction to identify that it is intended for the first party. For example, the first information transaction identifier may include the first public key. In some embodiments, a transaction identifier may include one or more of a public key, a subject and/or topic associated with the information transaction, a keyword, a user/party identification, a conversation or thread identifier (e.g., to provide a common marking for a conversation back and forth between two or more parties), a specific and/or weighted cost of an information transaction (e.g., transactions between two parties may cost 0.0001 cents and thus be identifiable by such a charge), and/or other identifiers enabling the identification of information transactions intended for a given party.

In some embodiments, information and/or content that must be contained within a given transaction identifier may be provided to a user via one or more information transactions and/or alternative communication avenues. For example, Party A may email Party B to inform Party B to use #123456789 as a transaction identifier on an information transaction (e.g., communication) intended for Party A so that the identification module may recognize the information transaction as being intended for Party A. In another example, Party A may use #987654321 as a transaction identifier in a first information transaction intended for Party B and include a request and/or requirement that Party B use #987654321 as the transaction identifier in a second information transaction (e.g., a response to the first information transaction).

In some embodiments, identification module 124 may identify a source of a given information transaction to enable the intended recipient to provide a response to the given information transaction. The source of a given transaction may be identified based on one or more of a given transaction identifier, information included in the given information transaction, and/or other information. Identification module 124 may be configured to identify a second party as a source of the first information transaction. Thus, for example, the first party may respond to the second party via system 100.

In some embodiments, system 100 may be configured to enable one or more auditors to audit the information transactions held within the distributed ledger. Identification module 124 may be configured to identify one or more information transactions included in an audit. For example, an auditor may request to audit all information transactions provided and/or retrieved by system 100 for a given party. Thus, in this example, identification module 124 may be configured to identify all information transactions intended for the given party and all information transactions where the given party is a source.

In some embodiments, identification module 124 may be configured to identify one or more information transactions containing information that should be reported to an outside party. In one example, one or more information transactions including know your customer (KYC) data and/or anti-money laundering (AML) data, may be identified.

Retrieval module 126 may be configured to retrieve one or more information transactions identified as intended for a given party from the distributed ledger. Retrieval module 126 may retrieve the first information transaction from the distributed ledger. Retrieving the first information transaction from the distributed ledger may include one or more of enabling a user to access the first information transaction held within the distributed ledger, recording and/or providing a location of the first information transaction with the distributed ledger, copying the first information transaction for storage, receiving the first information transaction from a third party server configured to parse through the distributed ledger, obtaining the first information transaction from the distributed ledger, and/or other methods of retrieving the first information transaction from the distributed ledger.

In some embodiments, retrieval module 126 may be configured to retrieve information associated with information transactions identified by identification module 124 as being included in an audit. Retrieval module 126 may be configured to retrieve one or more of information describing the one or more information transactions determined to be included in the audit, information payloads included in the one or more information transactions determined to be included in the audit, the one or more information transactions determined to be included in the audit, and/or other information related to an audit.

In some embodiments, retrieval module 126 may be configured to retrieve one or more information transactions identified as transactions containing information that should be reported to an outside party. For example, one or more information transactions including know your customer (KYC) data and/or anti-money laundering (AML) data, may be retrieved.

Decryption module 128 may be configured to decrypt encrypted information included in one or more information transactions. The encrypted information may be decrypted with one or more private keys corresponding to the public keys with which the information was decrypted. Decryption module 128 may be configured to decrypt the first encrypted information with a first private key that corresponds to the first public key. In some embodiments, decryption module 128 may be configured to communicate with key module 122 in order to obtain one or more private keys for decrypting the information included in one or more information transactions.

In some embodiments, decryption module 128 may be configured to decrypt encrypted information included in the information payloads of the information transactions identified as transactions containing information that should be reported to an outside party. In one example, the encrypted information included in the information payloads of the information transactions identified, including know your customer (KYC) data and/or anti-money laundering (AML) data, may be retrieved. Once retrieved, the know your customer (KYC) data and/or anti-money laundering (AML) data may be packaged for an outside party (e.g., the Financial Crimes Enforcement Network (FinCEN)).

Presentation module 130 may be configured to facilitate presentation of encrypted information to one or more users through an electronic display. In some embodiments, the encrypted information presented to one or more users includes the decrypted encrypted information. Presentation module 130 may be configured to effectuate presentation of the first encrypted information through an electronic display to the first party. For example, the first encrypted information presented to the first party may be presented as decrypted first encrypted information.

In some embodiments, information module 132 may receive second information from one or more parties. The second information may include a response to information presented to the given party that is included in a given payload of a given information transaction intended for (e.g., received by) the given party. Information module 132 may be configured to receive second information from the first party. The second information may include a communication for the second party (e.g., a response to the first encrypted information).

In some embodiments, encryption module 134 may be configured to encrypt the second information received from one or more parties. The second information may be encrypted with one or more public keys to create second encrypted information. In some embodiments, encryption module 134 may be configured to communicate with key module 122 to obtain one or more public keys associated with one or more given parties. The one or more public keys obtained may be used to encrypt second information and/or other information intended for the given parties.

Encryption module 134 may be configured to encrypt the second information with a second public key associated with the second party. In some embodiments, the second public key may be obtained by key module 122. As such, the encryption module 134 may communicate with key module 122 to obtain the second public key. Encrypting the second information with the second public key may enable the second party, or a user associated with the second party possessing the corresponding second private key, to read the second encrypted information.

In some embodiments, second information may include information requested in a request for information. In some embodiments, the second encrypted information may include one or more types of content, such as, a message, an image, a document, a video, and/or other types of content. In some embodiments, responsive to the first encrypted information including a request for information, the second encrypted information may include the information requested in the request for information. For example, the second encrypted information may include and/or be associated with one or both of know your customer (KYC) data, anti-money laundering (AML) data, and/or other financial data.

In some embodiments, encryption module 134 may be configured to further encrypt information included in one or more information payloads of one or more information transactions with multiple public keys. Thus, in some embodiments, multiple private keys may be required to decrypt information included in one or more information payloads of one or more information transactions. For example, information may be encrypted with multiple public keys associated with multiple parties when information is intended to be viewed by the multiple parties in collaboration.

In some embodiments, encryption module 134 may be configured to encrypt the second information with a third public key associated with a third party. As such, a second private key and a third private key may be required to decrypt the second encrypted information. In some embodiments, the second encrypted information may include a first portion and a second portion. The first portion may be encrypted with the second public key associated with the second party. The second portion may be encrypted with a third public key associated with a third party. As such, the second party may be able to decrypt the first portion of the second encrypted information using the corresponding second private key. The third party may able to decrypt the second portion of the second encrypted information using a corresponding third private key.

In some embodiments, transaction module 136 may be configured to generate one or more information transactions. Transaction module 136 may generate a second information transaction. The second information transaction may include one or more of a second information transaction identifier associated with the second party; a second information payload; and/or other information. The second information payload may include second encrypted information. In some embodiments, the second information transaction may be generated by and/or on behalf of the first party to respond to the first information transaction. In some embodiments, the second encrypted information included in the second payload may include the first portion and the second portion as described herein.

In some embodiments, ledger module 138 may be configured to provide one or more information transactions including encrypted information to the distributed ledger. Ledger module 138 may be configured to provide the second information transaction, including the second information payload, to the distributed ledger (e.g., 142). In some embodiments, ledger module 138 may be configured to interface with a public distributed ledger (e.g., ledger 142). For example, the public distributed ledger may include a Ripple® ledger. In some embodiments, ledger module 138 may be configured to provide and/or manage a private distributed ledger.

In some embodiments, system 100 may provide one or more information transactions to and/or retrieve one or more information transactions from the distributed ledger. A determination of whether one or more information transactions, including one or more of the information exchanges provided by system 100, should be included in the distributed ledger may be made. The determination of whether to include the one or more information exchanges in the distributed ledger may be made based on a consensus protocol. The consensus protocol may define a process by which network participants (e.g., nodes/servers) may agree on changes and/or additions to the distributed ledger. For example, the consensus protocol may include a public consensus protocol. A public consensus protocol may include, for example, one or more of the Ripple® Protocol, the “mining” proof of work protocol implemented by Bitcoin, and/or other public consensus protocols. In another example, the consensus protocol may include a private and/or custom consensus protocol. In some embodiments, ledger module 138 may be configured to manage a private distributed ledger according to the custom consensus protocol. In some embodiments, responsive to the network participants reaching an agreement (i.e., consensus) on one or more changes and/or additions (e.g., to include one or more information transactions) to the distributed ledger, a new instance of the distributed ledger may be created and distributed to all network participants. The process may be repeated and each time a consensus is reached a new instance of the distributed ledger may be created. The new instance of the distributed ledger may include added information exchanges provided by system 100. The new instance of the distributed ledger may be immutable. Thus, the distributed ledger may provide a verifiable record of all of the information exchanges including various information transactions including encrypted information. In some embodiments, a record of all instances of the distributed ledger (e.g., a ledger chain, a blockchain) may be generated to provide a verifiable record of all instances of the distributed ledger. As such, in some embodiments, both a latest new instance of the distributed ledger and/or the record of all instances of the distributed ledger provide a verifiable record of the various information transactions retrieved and/or provided by system 100.

As noted above, servers 110, client computing platforms 140, ledger 142, and/or external resources 144 may be operatively linked via one or more electronic communication links. For example, such electronic communication links may be established, at least in part, via a network such as the Internet and/or other networks. It will be appreciated that this is not intended to be limiting, and that the scope of this disclosure includes embodiments in which servers 110, client computing platforms 140, ledger 142, and/or external resources 144 may be operatively linked via some other communication media.

A given client computing platform 140 may include one or more processors configured to execute machine-readable instructions. The machine-readable instructions may be configured to enable an expert or user associated with the given client computing platform 140 to interface with system 100, ledger 142, external resources 144, and/or provide other functionality attributed herein to client computing platforms 140. For example, as noted above, the given client computing platform 140 may include one or more of a desktop computer, a laptop computer, a handheld computer, a tablet computing platform, a netbook, a smartphone, a gaming console, and/or other computing platforms.

Ledger 142 may include a system, computing platforms, servers, electronic storage, external resources, processors, and/or other modules associated with a distributed ledger. System 100, client computing platforms 140, external resources 144, and/or other modules may be configured to communicate with ledger 142. In some embodiments, ledger 142 may include one or more servers participating in connection with servers 110 to provide a distributed ledger.

External resources 144 may include sources of information, hosts and/or providers of transaction platforms outside of system 100, external entities participating with system 100, and/or other resources. In some embodiments, some or all of the functionality attributed herein to external resources 144 may be provided by resources included in system 100.

Servers 110 may include electronic storage 146, one or more processors 120, and/or other modules. Illustration of servers 110 in FIG. 1 is not intended to be limiting. Servers 110 may include a plurality of hardware, software, and/or firmware modules operating together to provide the functionality attributed herein to servers 110. For example, server 110 may be implemented by a cloud of computing platforms operating together as server 110.

Electronic storage 146 may comprise non-transitory storage media that electronically stores information. The electronic storage media of electronic storage 146 may include one or both of system storage that is provided integrally (i.e., substantially non-removable) with a respective module of system 100 and/or removable storage that is removably connectable to a respective module of system 100 via, for example, a port (e.g., a USB port, a firewire port, etc.) or a drive (e.g., a disk drive, etc.). Electronic storage 146 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 146 may include one or more virtual storage resources (e.g., cloud storage, a virtual private network, and/or other virtual storage resources). Electronic storage 146 may store software algorithms, information determined by a processor, and/or other information that enables modules of system 100 to function as described herein.

Processors 120 may be configured to provide information processing capabilities in servers 110. As such, processors 120 may include one or more of a digital processor, an analog processor, a digital circuit designed to process information, an analog circuit designed to process information, a state machine, and/or other mechanisms for electronically processing information. Although processor 120 is shown in FIG. 1 as a single entity, this is for illustrative purposes only. In some embodiments, processors 120 may include a plurality of processing units. The processors 120 may be configured to execute machine-readable instructions 121. Machine-readable instructions 121 may include modules 122, 124, 126, 128, 130, 132, 134, 136, 138, and/or other modules. The processors 120 may be configured to execute modules 122, 124, 126, 128, 130, 132, 134, 136, 138, and/or other modules by software; hardware; firmware; some combination of software, hardware, and/or firmware; and/or other mechanisms for configuring processing capabilities on processors 120.

The description of the functionality provided by the different modules 122, 124, 126, 128, 130, 132, 134, 136, and/or 138 described herein is for illustrative purposes, and is not intended to be limiting, as any of modules 122, 124, 126, 128, 130, 132, 134, 136, and/or 138 may provide more or less functionality than is described. For example, one or more of modules 122, 124, 126, 128, 130, 132, 134, 136, and/or 138 may be eliminated, and some or all of its functionality may be provided by other ones of modules 122, 124, 126, 128, 130, 132, 134, 136, and/or 138. As another example, processors 120 may be configured to execute one or more additional computer readable instruction modules that may perform some or all of the functionality attributed below to one of modules 122, 124, 126, 128, 130, 132, 134, 136, and/or 138.

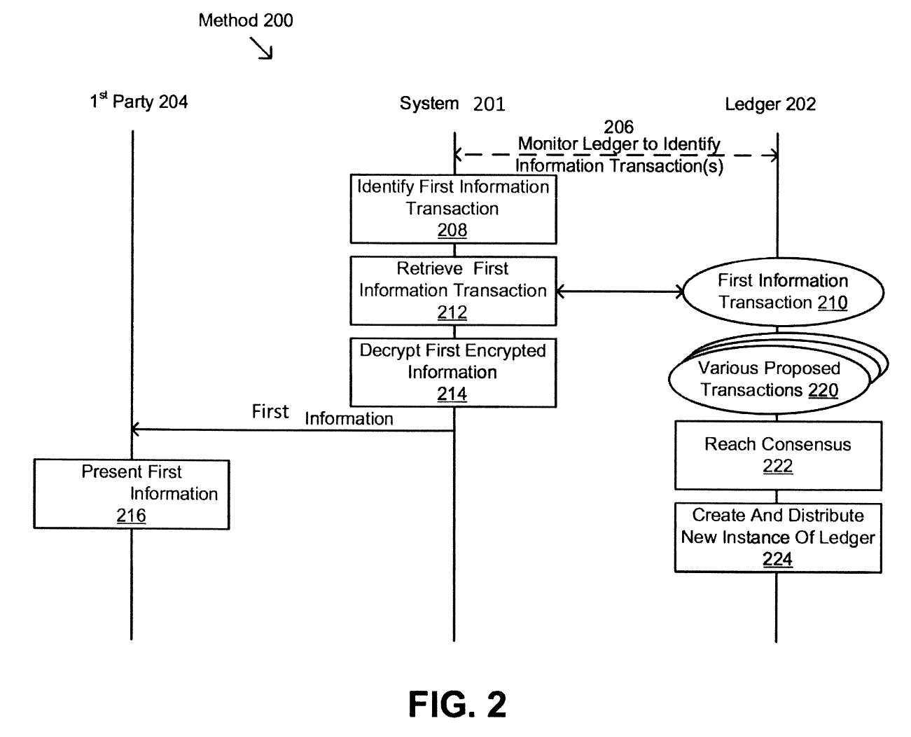

FIG. 2 illustrates a method 200 for providing a cryptographic platform for exchanging information, in accordance with one or more embodiments. The described operations may be accomplished using some or all of the system modules described in detail herein and, in some embodiments, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are examples by nature and, as such, should not be viewed as limiting.

Method 200 in FIG. 2 depicts an example data flow between one or more of ledger 202, a system server 201, a first client computing platform 204, and/or other platforms. System server 201 may be the same as or similar to one or more servers 110 (e.g., see FIG. 1). Ledger 202 may include computing platforms, servers, and/or other modules of a systems associated with a distributed ledger that is the same as or similar to ledger 142 (e.g., see FIG. 1). First client computing platform 204 may be associated with the first party and may be the same as or similar to one or more client computing platforms 140 (e.g., see FIG. 1).

In some embodiments, one or more operations of method 200 may be implemented in and/or by one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

In some embodiments, at operation 206, system 201 may be configured to monitor ledger 202 to identify one or more information transactions. Operation 206 may be performed by one or more processors configured to execute an identification module that is the same as or similar to identification module 124, in accordance with one or more embodiments. At operation 208, a first information transaction 210 may be identified by system 201. The first information transaction 210 may be held within ledger 202. The first information transaction 210 may include information intended for the first party. The first information transaction 210 may include one or more of: a first information transaction identifier associated with the first party; a first information payload; and/or other information. The first information payload may include first encrypted information. The first encrypted information may be encrypted with a first public key associated with the first party. Operation 208 may be performed by one or more processors configured to execute an identification module that is the same as or similar to identification module 124.

At operation 212, the first information transaction 210 may be retrieved from ledger 202. Operation 212 may be performed by one or more processors configured to execute a retrieval module that is the same as or similar to retrieval module 126, in accordance with one or more embodiments. At operation 214, the first encrypted information may be decrypted with a first private key that corresponds to the first public key. Operation 212 may be performed by one or more processors configured to execute a decryption module that is the same as or similar to decryption module 128.

At operation 216, presentation of the decrypted first information to the first party may be facilitated through an electronic display of the first client computing platform 204. Operation 216 may be performed by one or more processors configured to execute a presentation module that is the same as or similar to presentation module 130.

In some embodiments, at a given point in time, ledger 202 may include various proposed information transactions 220. At operation 222, ledger 202 may reach a consensus via a consensus protocol. At operation 224, a new instance of the distributed ledger may be created and distributed. In some embodiments, operation 222 and operation 224 may be performed by one or more processors configured to execute a ledger module that is the same as or similar to ledger module 138. In some embodiments, operation 222 and operation 224 may be performed by one or more servers associated with a public distributed ledger.

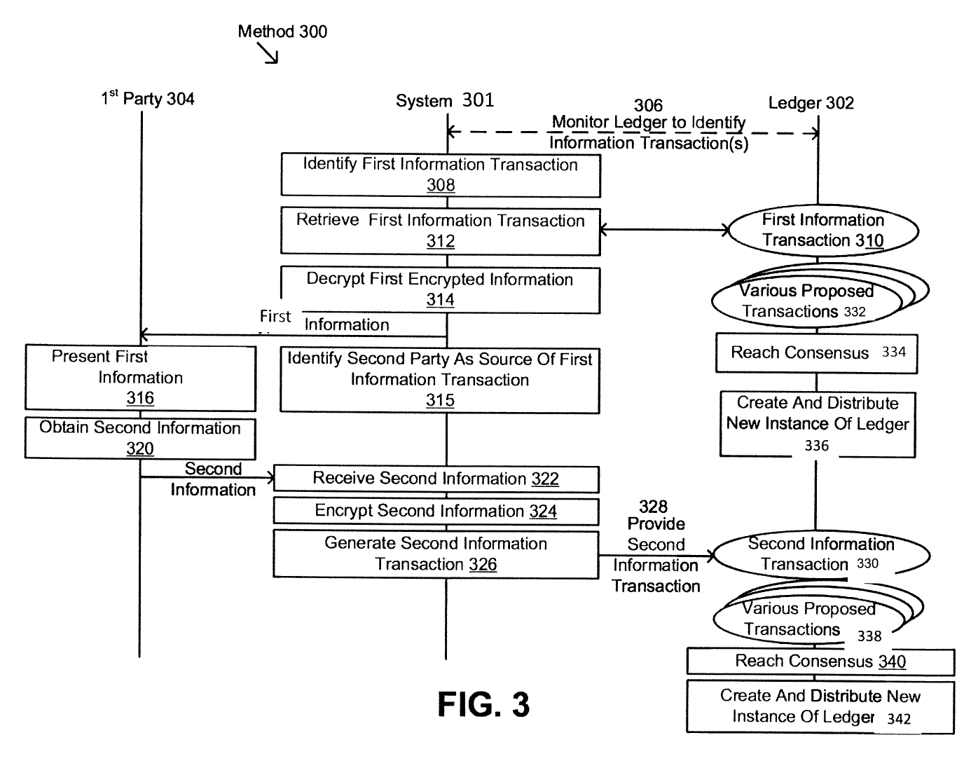

FIG. 3 illustrates a method 300 for providing a cryptographic platform for exchanging information, in accordance with one or more embodiments. The described operations may be accomplished using some or all of the system modules described in detail herein and, in some embodiments, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are examples by nature and, as such, should not be viewed as limiting.

Method 300 in FIG. 3 depicts an illustrative data flow between one or more of a ledger 302, a system server 301, a first client computing platform 304, and/or other platforms. System server 301 may be the same as or similar to one or more servers 110 (e.g., see FIG. 1). Ledger 302 may include computing platforms, servers, and/or other modules of a systems associated with a distributed ledger that is the same as or similar to ledger 142 (e.g., see FIG. 1). First client computing platform 304 may be associated with the first party and may be the same as or similar to one or more client computing platforms 140 (e.g., see FIG. 1).

In some embodiments, one or more operations of method 300 may be implemented in and/or by one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

In some embodiments, at operation 306, system 301 may be configured to monitor ledger 302 to identify one or more information transactions. Operation 306 may be performed by one or more processors configured to execute an identification module that is the same as or similar to identification module 124, in accordance with one or more embodiments. At operation 308, a first information transaction 310 may be identified by system 301. The first information transaction 310 may be held within ledger 302. The first information transaction 310 may include information intended for the first party. The first information transaction 310 may include one or more of: a first information transaction identifier associated with the first party; a first information payload; and/or other information. The first information payload may include first encrypted information. The first encrypted information may be encrypted with a first public key associated with the first party. Operation 308 may be performed by one or more processors configured to execute an identification module that is the same as or similar to identification module 124.

At operation 312, the first information transaction 310 may be retrieved from ledger 302. Operation 312 may be performed by one or more processors configured to execute a retrieval module that is the same as or similar to retrieval module 126, in accordance with one or more embodiments. At operation 314, the decrypted first information may be decrypted with a first private key that corresponds to the first public key. Operation 314 may be performed by one or more processors configured to execute a decryption module that is the same as or similar to decryption module 128.

At operation 315, a second party may be identified by system 304 as a source of the first information transaction. Operation 315 may be performed by one or more processors configured to execute an identification module that is the same as or similar to identification module 124. At operation 316, presentation of the first encrypted information to the first party may be facilitated through an electronic display of the first client computing platform 304. Operation 316 may be performed by one or more processors configured to execute a presentation module that is the same as or similar to presentation module 130. In some embodiments, at operation 320, the first client computing platform 304 may obtain second information. Second information may be submitted by other clients interacting with the client computing platform 304. For example, a contract involving the client of FIG. 3 that has been submitted by a second client may constitute second information for the original client.

In some embodiments, at operation 322, the second information may be received by system 301. The second information may include a communication for the second party. Operation 322 may be performed by one or more processors configured to execute an information module that is the same as or similar to information module 132. At operation 324, the second information may be encrypted. The second information may be encrypted with a second public key associated with the second party. Operation 324 may be performed by one or more processors configured to execute an encryption module that is the same as or similar to encryption module 134.

In some embodiments, at operation 326, a second information transaction 330 may be generated. The second information transaction may include one or more of: a second information transaction identifier associated with the second party; a second information payload; and/or other information. The second information payload may include second encrypted information. Operation 326 may be performed by one or more processors configured to execute a transaction module that is the same as or similar to transaction module 136. At operation 328, the second information transaction 330 may be provided to ledger 302 (e.g., the distributed ledger). The second information transaction 330 provided to ledger 302 may include the second information payload.

In some embodiments, at a given point in time, ledger 302 may include various proposed information transactions 332. At operation 334, ledger 302 may reach a consensus via a consensus protocol. At operation 336, a new instance of the distributed ledger may be created and distributed. The new instance of the ledger 302 may include various proposed information transactions 338 including second information transaction 330. At operation 340, ledger 302 may reach a consensus via a consensus protocol. At operation 342, a new instance of the distributed ledger, including the addition of the second information transaction 330, may be created and distributed. In some embodiments, operation 334 through operation 342 may be performed by one or more processors configured to execute a ledger module that is the same as or similar to ledger module 138. In some embodiments, operation 334 through operation 342 may be performed by one or more servers associated with a public distributed ledger.

### Event Synchronization

As discussed above with respect to cryptographic data exchange generally, in some embodiments, the system may include one or more servers. The servers may be configured to communicate with one or more client computing platforms according to a client/server architecture. The parties may access the system via client computing platforms.

In some embodiments, the systems and/or methods for providing a cryptographic platform for exchanging information as described herein may be used as a means of event synchronization from one to many and/or many to one (e.g., from one party to multiple parties and/or from multiple parties to one party). In some embodiments, the parties may include one or more of multiple end parties, multiple sub-parties of a single party (e.g., to facilitate exchange of information internally and/or among subordinate entities), and/or other parties.

The servers may be configured to execute machine-readable instructions. The machine-readable instructions may include one or more of a key module, an identification module, a retrieval module, a decryption module, a presentation module, an information module, an encryption module, a transaction module, a ledger module, a presentation module, and/or other modules.

The system may be configured similarly to the cryptographic data exchange system described above with respect to FIGS. 1-3.

In some embodiments, the system may include a key module, an identification module, a retrieval module, an information module, an encryption module, a decryption module, an event module (which may be similar to the transaction module described above), a ledger module, and/or other modules. These modules may comprise special-purpose hardware and/or software.

The key module may be configured to provide a first public key associated with a first party to a second party. The first public key may be provided to the second party to enable information intended for the first party to be encrypted with the first public key. In some embodiments, the key module may be configured to obtain a second public key associated with a second party.

The identification module may be configured to identify a first information transaction. The first information transaction may include information intended for the first party. One or more information transactions, including the first information transaction, may be held within a distributed ledger. The distributed ledger may provide a verifiable record of one or more information transactions. The first information transaction may include one or more of a first information transaction identifier associated with the first party; a first information payload; and/or other information. The first information payload may include first encrypted information. The first encrypted information may be encrypted with a first public key associated with the first party. In some embodiments, the first information transaction identifier may not be encrypted. In some embodiments, the first information transaction identifier may include the first public key. In some embodiments, the identification module may be configured to identify a second party as a source of the first information transaction. In some embodiments, the identification module may be configured to identify one or more information transactions included in an audit.

The retrieval module may be configured to retrieve the first information transaction from the distributed ledger. The distributed ledger may provide a verifiable record of various information transactions including various information payloads that include various encrypted information that is encrypted with various public keys. In some embodiments, the retrieval module may be configured to retrieve one or more of information describing the one or more information transactions determined to be included in the audit, information payloads included in the one or more information transactions determined to be included in the audit, the one or more information transactions determined to be included in the audit, and/or other information related to an audit.

The decryption module may be configured to decrypt the first encrypted information with a first private key that corresponds to the first public key.

The presentation module may be configured to facilitate presentation of the first encrypted information through an electronic display to the first party.

In some embodiments, the information module may receive second information from the first party. The second information may include a communication for the second party (e.g., a response to the first encrypted information).

In some embodiments, the encryption module may be configured to encrypt the second information with a second public key associated with the second party. In some embodiments, the encryption module may be configured to encrypt the second information with a third public key associated with a third party. As such, a second private key and a third private key may be required to decrypt the second encrypted information.

In some embodiments, the first encrypted information may include a request for information. The second encrypted information may include information requested in the request for information. The first encrypted information and/or the second encrypted information may include one or more of a message, an image, a document, a video, and/or other types of content. For example, the first encrypted information and/or the second encrypted information may include one or more of know your customer (KYC) data; anti-money laundering (AML) data; and/or other financial data.

In some embodiments, the event module may be configured to generate a second information transaction. The second information transaction may include one or more of a second information transaction identifier associated with the second party; a second information payload; and/or other information. The second information payload may include second encrypted information. In some embodiments, the second encrypted information included in the second payload may include a first portion and a second portion. The first portion may be encrypted with the second public key associated with the second party. The second portion may be encrypted with a third public key associated with a third party. In some embodiments, the second portion may be encrypted with the third public key.

In some embodiments, the ledger module may be configured to provide the second information transaction, including the second information payload, to the distributed ledger. In some embodiments, the ledger module may be configured to interface with a public distributed ledger. In some embodiments, the ledger module may be configured to manage a private distributed ledger according to a custom consensus protocol. Managing the distributed ledger may include implementing the custom consensus protocol to create verified instances of the distributed ledger.

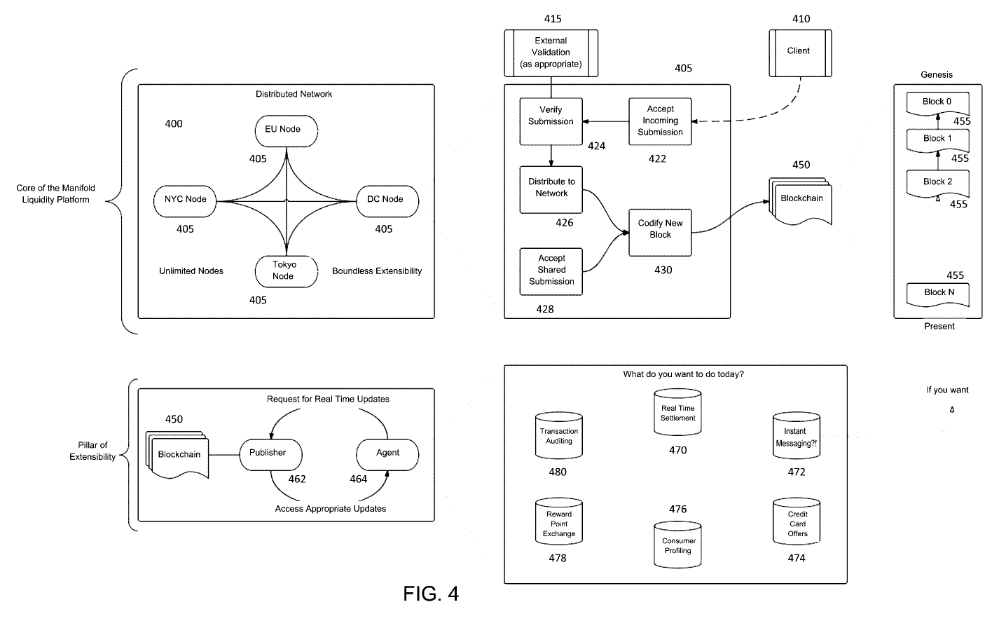

FIG. 4 illustrates an event synchronization network 400 according to an embodiment of the invention. The network 400 may include a plurality of nodes 405. Each node 405 may comprise a system 100 of FIG. 1, for example. Four nodes 405 are shown, but any number of nodes 405 may be possible. FIG. 4 also shows one of the nodes 405 (the DC node) expanded to illustrate the connection between a node 405 and a client 410 and/or external validation provider 415.

The expanded node 405 also includes actions which may be performed by the node 405 during an interaction between the node 405 and the client 410. One or more clients 410 may connect to one or more of the nodes 405 in the network 400. The client 410 may request a transaction, such as one of the example transactions 470-480 of FIG. 4 (real time settlement 470, instant messaging 472, credit card offer 474, consumer profiling 476, reward point exchange 478, and/or transaction auditing 480). The node 405 may accept incoming submissions 422 and verify the submission 424. In some embodiments, the node 405 may contact an external validation server 415 for validation (e.g., to validate a user's identity, payment information, account information, etc.). Once verified, the submission may be distributed to the network 426. Likewise, shared submissions (e.g., submissions of financial transactions submitted jointly by both parties to the transaction) may be accepted 428. In either case, the submission may be used to codify a new block 430 for a blockchain 450 (i.e., a distributed ledger). The new block 455 (e.g., block N) may be added the latest block in the blockchain 450 and thus the latest entry in the ledger.

The publisher 462 may enable a client 464 to request real time updates about some or all events entering the blockchain 450. This request may be done by filter, for example “give all events which match requirement set A” or “give all events which fail to match requirement set B”. The real time updates may be pushed from the publisher 462 to the client 464, enabling the client to be event driven (e.g., supporting use cases like http requests, instant messaging, balance updates, or alerts).

FIG. 5 illustrates an event synchronization method 500 according to an embodiment of the invention. FIG. 5 provides a more detailed view of the interaction between client 410 and node 405, and between the various nodes 405, during a transaction such as that presented in FIG. 4 above, for example. A submitter may identify an event to be stored 505 (e.g., a user may initiate a transaction at a client 410, and the client 410 may recognize that data associated with the transaction is to be stored in the distributed ledger). An event may be any set of information (which may be verified and/or validated) pertaining to an activity conducted at a point in time (e.g., the transaction). The client 410 may connect to a node 405 (an originating node) 510. Information about the event to be stored may be submitted 515 from the client 410 to the node 405. This information may include a verifiable fact about the event (e.g., user identity, credit card number, etc.). The fact may be passed from the node 405 to a validation subsystem 415 for verification 520 (and/or may verify the fact itself). The validation subsystem 415 may verify the fact, and the originating node 405 may queue the event for codification (recordation in a block in the blockchain, for example) 525. Queued events may be shared with other nodes 405 in the network 400 for codification 530. Each node 405 may independently validate events 535, for example by passing the facts to validation subsystems 415, in some embodiments. Some subset of pending events may join the next event queue in every node 405 in the network 400 for entry into the consensus protocol 540. In some embodiments, some or all of these actions 505-540 may be performed by the event module of the node 405, for example.

Events in the event queue may be subjected to the consensus protocol to be written into the distributed ledger. Block negotiation may be initiated 545 (e.g., at regular intervals such as every second). Each node 405 may share with every other node 405 a list of the hashes of the events in their next event queues 550. Upon receipt, each node 405 may have knowledge of every other node's 405 event queue 555. Each event may include a header (e.g., including an ID and the IDs of involved parties) as well as the data (e.g., the transaction amount, a pdf of the contract, an instant message, etc.). The entire event data structure may be passed to the SHA256 hashing algorithm (though any robust hashing algorithm may be used). The hash of the event may be created after the event has been validated and before it is shared with the other nodes. The hash may be used as short hand between the nodes, as each node may have an independent copy of the underlying event after it has been shared.

Each node 405 may independently identify the greatest common set of shared events 560. Each node 405 may independently create a block containing all identified events 565 and may share with each other node 405 a hash of its independently created block 570. Each node 405 may verify that every other node 405 created the same block (e.g., by checking whether the hashes match) 575. If so, the block may be written in the blockchain, codifying the set of events within 580. Thus, only information which is commonly agreed upon by each node 405 is written in the distributed ledger, providing a trustworthy record of the event. Each node 405 may write the block in the blockchain, and the block is not shared. Only the hashes of the blocks may be shared in order to validate that each node 405 has independently come to the correct conclusion. In some embodiments, every node 405 in the network 400 may be required to agree, thereby forming a 100% consensus quorum, in order to write a block. In other embodiments, a different consensus quorum of nodes 405 may be required (e.g., 80%, 51%, etc.) to agree in order to write an event. In some embodiments, some or all of these actions 545-580 may be performed by the ledger module of the node 405, for example.

FIG. 6 illustrates a consensus protocol method 600 according to an embodiment of the invention. FIG. 6 provides a more detailed view of the consensus protocol 545-580 performed between the various nodes 405 in FIG. 5 above, for example. Block negotiation may begin 605 (e.g., initiated every second by a timer). Each node 405 may share with every other node 405 a list of the hashes of the events in their next event queues 610.

Each node 405 may independently determine whether every node has received queues 615 and, if not, whether a minority failed to arrive 620. Because each node 405 may know specifically which other nodes' 405 queues they have received, they may uniquely identify which other node(s) 405 may be responsible for a timeout. If a minority did not fail to arrive, a node 405 that did not receive the queues may be in passive mode (i.e., the other nodes 405 may no longer wait on it) and may attempt to fix itself (e.g., reestablish network connection) and rejoin the network 400 when possible 625. In some embodiments, the node 405 causing a timeout may be removed from active status after it fails to receive the queues a configurable number of times in a row. If a minority failed to arrive, the nodes 405 in that minority may be placed in passive mode 630, and events may be re-queued for the next block 665.

In order to correctly write a block, each of the nodes 405 may need to have every other active node's 405 event list. If an event list is missing from a subset of nodes 405 due to timeout, their block calculation may be inaccurate and that round of consensus may fail, triggering a re-queueing of events and a new round. Because all nodes 405 may share their block hashes with all other nodes 405, a node 405 having trouble may be able to independently determine that it is the cause of the problem if it is in the minority insofar as block hash agreement is concerned, or if it is suffering the majority of nodes 405 timing out.

If every node 405 receives the queued data, each node 405 may now have knowledge of each other node's 405 event queue 635. Each node 405 may independently identify the greatest common set of shared events 640. If the number of nodes 405 that can agree upon a greatest common set of shared events is lower than the number of nodes 405 required for a consensus quorum, events may be re-queued for the next block 610. If the number of nodes 405 that can agree upon a greatest common set of shared events is equal to or greater than the number of nodes 405 required for a consensus quorum, each node 405 may independently create a block containing all identified events 645.

Each node 405 may share with each other node 405 a hash of its independently created block 650. Each node 405 may independently determine whether every node receives block hashes 655 and independently determine whether all hashes agree 660. If all hashes agree 660, the block may be written, codifying the set of events within 670. If not, events may be re-queued for the next block 665. If not every node 405 received block hashes, the node 405 or nodes 405 that failed to receive every block hash may fail to write the block and begin the next round assuming that block was not written (referencing the block before it, X-1, as the previous block). Each of the other subset of nodes 405 that received all the hashes may believe every node 405 agreed to write the block, may write the block, and may create the next block referencing block X as the previous block. Blocks X and X-1 may not result in the same block hash. Failure to create the same hash may trigger a panic mode whereby the nodes 405 all share information about the previously written blocks such that they can each determine whether they are in the minority, and thus wrong, about the current state of the system. Should no quorum of identical state information exist, the system as a whole may halt and await human intervention.

Each node 405 may independently determine whether every node receives queues 615 and independently determine whether a minority failed to arrive 620. By each node 405 focusing solely on whether it has every queue itself, the nodes 405 may be able to determine whether a timeout/failure to deliver that they are aware of has occurred, thus triggering a failed consensus and a re-queueing for the next round. If the nodes 405 determine that queues were shared correctly, the nodes 405 may write the current block. During the next round of negotiation, any discrepancy between a given node 405 and the rest of the network may present itself and, if necessary, corrective action may be taken at that time. If a minority did not fail to arrive, a node 405 that did not receive the queues may be in passive mode and may attempt to fix itself (e.g., reestablish network connection) and rejoin the network 400 when possible 625. If a minority failed to arrive, the nodes 405 in that minority may be placed in passive mode 630, and events may be re-queued for the next block 665.

The above-described systems and methods may provide trustworthy, verifiable, and secure transaction records, as illustrated by the example applications discussed below. Through the use of the disclosed systems and methods, sensitive information may be stored and processed in a distributed network of nodes in an efficient, scalable, and tamper-proof manner.

### Example Applications

The systems and methods described herein may be used for creation and administration of a dynamically interoperable loyalty rewards exchange. The system described above may allow the value of loyalty rewards from independent rewards programs to be stored in a single distributed ledger by multiple parties simultaneously. Each independent reward system's points (miles, bucks, points, etc.) may function as an independent commodity in the system and may be traded in whole or part to other users of the system for other goods/services/currencies. The system may also allow exchange of one type of reward point commodity for another at either a system enforced, or dynamically agreed upon, rate.

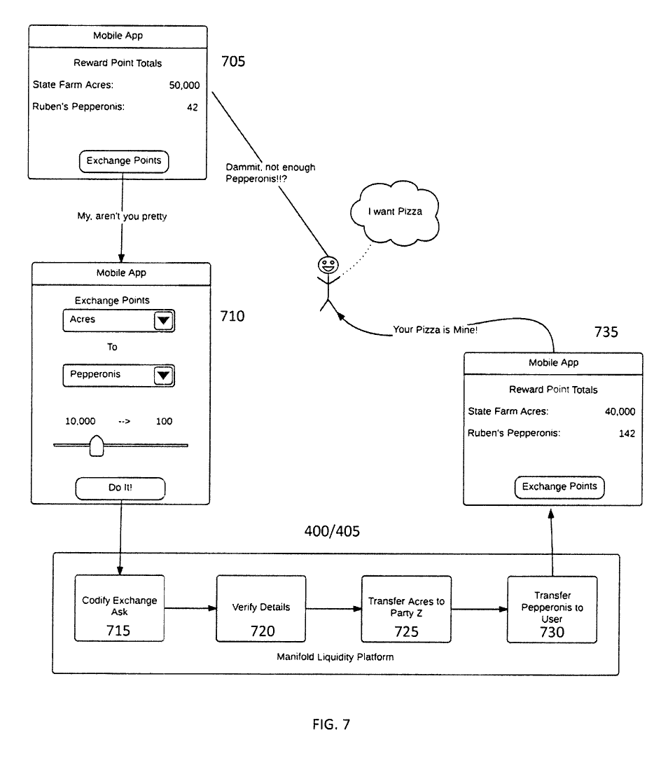

FIG. 7 illustrates a rewards exchange method 700 according to an embodiment of the invention. A user may be enrolled in a plurality of rewards programs, and may wish to redeem rewards points for a particular transaction. For example, the user in FIG. 7 has 50,000 acres in one program and 42 pepperonis in another. The user wants to redeem pepperonis for a pizza purchase. Using a client device 410 (e.g., a smart phone, tablet, PC, etc.), the user may initiate a points exchange process 705. The user may enter a transaction (e.g., 10,000 acres to 100 pepperonis) 710, and the client 410 may send transaction information to a node 405 in the network 400. The transaction may be processed according to the cryptographic exchange methods described above with respect to FIGS. 4-6. For example, the exchange request may be codified 715, and details about the request may be verified 720 (e.g., via 505-540 of FIG. 5). The points may be exchanged as specified by the user (e.g., the user's acres may be transferred to a party Z holding pepperonis 725, and party Z's pepperonis may be transferred to the user in exchange 730). The transfer may be performed by writing the transaction to the distributed ledger (e.g., via 545-580 of FIG. 5 and/or the process 600 of FIG. 6). The node 405 may notify the client 410 that the exchange has been completed, and the new points balances may be displayed to the user 735. The user may now exchange pepperonis for a pizza.

The systems and methods described herein may provide immediate earning of rewards points without legacy payment system impact. The system described above may provide immediate synchronization of assets and information across institutions and devices. As a result, a commercial entity may immediately update customer reward point accounts based on credit card transaction authorizations in coordination with credit card account authorization or transaction processing entities. The updated account information may be made immediately available to customers on mobile devices following online or in-store credit card purchases without requiring any interaction with point of sale systems.

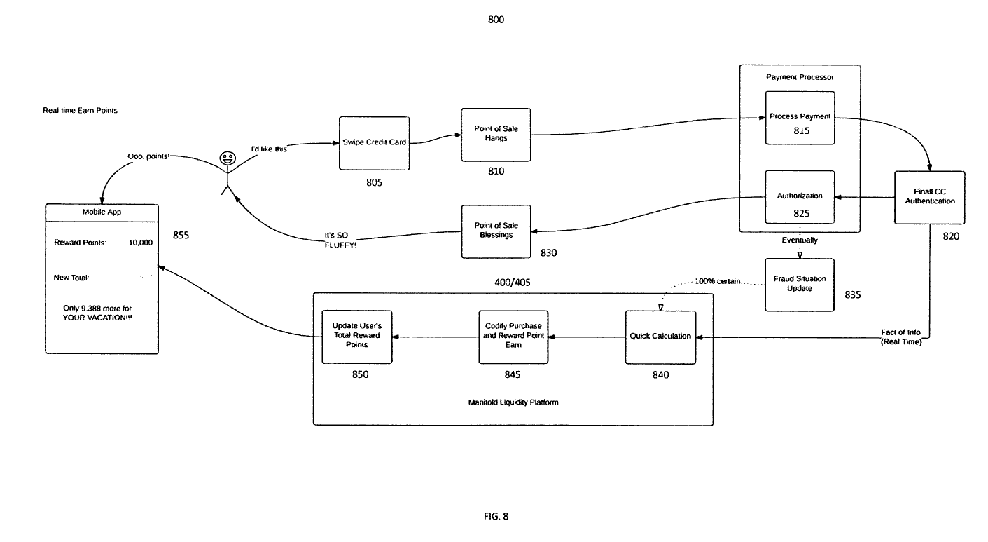

FIG. 8 illustrates a rewards earning method 800 according to an embodiment of the invention. A user may purchase an item using a credit card. The user may swipe their credit card at a point of sale 805 as shown (or enter the credit card information online, etc.). The point of sale may hang 810 and send the credit card information to a payment processor. The payment processor may process the payment 815 and submit the credit card information for authentication 820. On the transaction side, the authentication 820 may be provided to the payment processor, which may authorize the transaction 825. The point of sale may receive the authorization and complete the sale 830. The credit card authorization may also be shared with a node 405 on the network 410 as a fact to be used in updating the distributed ledger. Additionally, in some embodiments, the payment processor may provide an updated fraud report 835 (e.g., indicating that the sale was not fraudulent). This fraud information may also be sent to the node 405. The node 405 may verify the authentication with the fraud information 840 when available. Once the sale is thus confirmed as valid, the node 405 may codify the purchase and reward point earn (e.g., points earned for use of the credit card) 845 (e.g., via 505-540 of FIG. 5). The distributed ledger may be updated with the user's total reward points 850 (e.g., via 545-580 of FIG. 5 and/or the process 600 of FIG. 6). The node 405 may notify a client 410 (e.g., a smart phone, tablet, PC, etc.) that the exchange has been completed, and the new points balance may be displayed to the user 855 via the client.

The systems and methods described herein may provide immediate rewards application toward partial or full payments without legacy payment system impact. The system described above may provide immediate synchronization of assets and information across institutions and devices. As a result, a commercial entity may give its customers the option of selecting existing rewards points in their account to apply against in-store or online credit card purchases. The commercial entity may use the system to synchronize with credit card account authorizers or processors and refund to the customer's card the corresponding cash value of the rewards points that were applied.

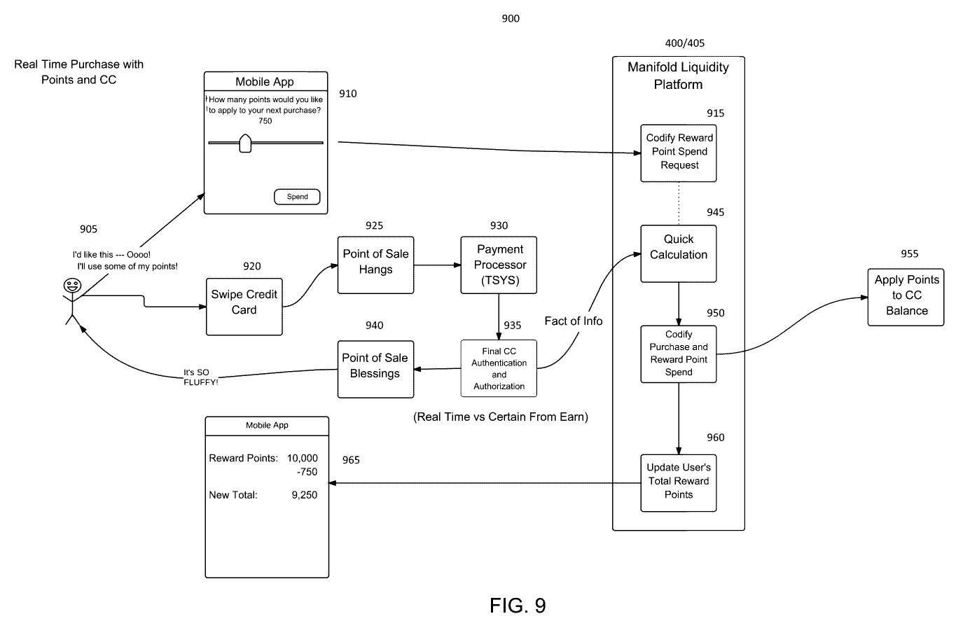

FIG. 9 illustrates a rewards synchronization method 900 according to an embodiment of the invention. A user may initiate a transaction using a combination of points and credit 905. The user may specify a number of points to use 910 via a client device 410 (e.g., a smart phone, tablet, PC, etc.). The client 410 may send information about the points spent to a node 405 of the network. The node 405 may codify the reward point spend request 915. The user may swipe their credit card at a point of sale 920 to pay the balance on the purchase as shown (or enter the credit card information online, etc.). The point of sale may hang 925 and send the credit card information to a payment processor. The payment processor may process the payment 930 and submit the credit card information for authentication 935. The point of sale may receive the authorization and complete the sale 940. The credit card authorization may also be shared with the node 405 as a fact to be used in updating the distributed ledger. The node 405 may validate the facts of the point spend and credit card authorization 945 and codify purchase and reward point spend 950 (e.g., via 505-540 of FIG. 5). The node 405 may send data about the points spent to a credit card (or other points program) processor to allow the credit card processor to apply the points to the points balance 955. The node 405 may update the user's total reward points in the distributed ledger 960 (e.g., via 545-580 of FIG. 5 and/or the process 600 of FIG. 6). The node 405 may notify the client 410 that the transaction has been completed, and the new points balance may be displayed to the user 965.

The systems and methods described herein may provide mechanism for immediate of purchase insights and correspondingly tailored incentive offers for commercial entities to their customers. The system described above may provide immediate synchronization of assets and information across institutions and devices. As a result, a commercial entity may receive purchasing data from system software on the customer's mobile device and may apply analytics against the data to determine appropriate offerings to incentivize greater customer loyalty or additional spending. Using the system described above, the commercial entity may display such incentive offerings immediately on the customer's device. Information about an individual stored by the system may represent the totality of a customer's financial interactions with any and all other entities (e.g., in-store purchases, mortgages, refinances, 401K utilization, new credit cards, credit card payments, etc.). Offers may be tailored with fine granularity based on a totality of customer insight.

The systems and methods described herein may be used to generate legally binding asynchronous contractual agreements and publish them in a cryptographic ledger. The system enables the generation of a legally binding contract wherein a party may formally agree to act under a given, arbitrary, set of conditions. Once such a contract is published to the ledger, any event enacting/concluding/providing for those set of conditions may trigger the aforementioned actions on the part of the initial party. No further action may be required by either party to codify the contract, though the system may compile fact of completion in a cache for ease of use.

The systems and methods described herein may provide template-driven contract creation, publishing, and rescinding. The system described above may provide a distributed cryptographic ledger that supports the publishing of immutable event records. In some embodiments, the system may enable the generation of legally binding contractual agreements that may be constructed from a pool of possible legal provision templates by agreement offerors which may then be matched and executed automatically by the system. Upon acceptance of an offer, the system may provide for the immediate codification and publishing of the agreement as an immutable record.

The systems and methods described herein may automate the identification, execution, and management of advantageous financial instruments. The system described above may allow for disparate financial instruments to be stored in a single distributed ledger by one or multiple parties simultaneously. As a result, the system may allow disparate financial instruments to be dynamically exchanged manually or automatically when certain conditions are met. In some embodiments, the system may enable the automatic exchange with rule-based management that provides for advantageous transfers of value in accordance with customer preferences.

The systems and methods described herein may create, execute, and enforce financial planning. The system described above may allow for a customer's assets to be stored in a single distributed ledger and may allow for dynamic transfers of assets manually or automatically when certain conditions are met. In some embodiments, the system may enable the management of accounts with an interface that allows customers to set rules governing the assets, and the rules may be self-executing to enforce financial planning.

The systems and methods described herein may enable automatic rule-based micro-investment and borrowing. The system described above may allow users to automatically offer and accept micro loans under conditions they define. The system may allow users to bundle these micro-loans into larger instruments where possible/appropriate, enabling a robust peer-to-peer investment and borrowing platform.

The systems and methods described herein may enable the fluid interoperability of disparate private financial ledgers. The system described above may allow all interested parties to have direct control over what gets accepted into a shared ledger by having each party join as an independent node of the system. The parties may then be able to operate in good faith moving value onto and off of the shared ledger in mathematically enforced cooperation.

While various embodiments have been described above, it should be understood that they have been presented by way of example and not limitation. It will be apparent to persons skilled in the relevant arts that various changes in form and detail can be made therein without departing from the spirit and scope. In fact, after reading the above description, it will be apparent to one skilled in the relevant arts how to implement alternative embodiments. For example, various applications of the systems and methods described herein may include exchange of financial information; managing rewards points; storing and exchanging transaction-specific payment tokens; facilitating remittance services; reconciling accounts across disparate entities (e.g., subsidiaries and/or partners); consolidating discrete business unit or private ledgers; replacing legacy core settlement systems; transferring health care information; and/or other applications.

In addition, it should be understood that any figures that highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims, and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A system for providing distributed event synchronization, the system comprising:
a plurality of nodes in communication with one another via a network, each node comprising:
a processor;
a memory;
an event module in communication with the processor and the memory and configured to:
receive data about an event to be codified in a distributed ledger; and
place the event in an event queue for distributed block negotiation; and
a ledger module in communication with the processor and the memory and configured to perform the block negotiation with at least one other node in the network by:
sharing the event queue;
determining a greatest common set of shared events comprising the event;
when a consensus quorum of the plurality of nodes has determined the greatest common set, creating a block comprising the greatest common set of shared events;
sharing local data relating to the block;
receiving additional data relating to the block from the at least one other node; and
when the local data and the additional data agree, writing the block into a distributed ledger shared by the memory of each of the plurality of nodes.

2. The system of claim 1, wherein:
the local data comprises a local hash of the block; and
the ledger module is further configured to generate the local hash of the block.

3. The system of claim 1, wherein the additional data comprises at least one additional hash from the at least one other node.

4. The system of claim 1, wherein the event module is further configured to verify at least one fact in the data about the event.

5. The system of claim 4, wherein verifying the at least one fact comprises receiving verification from a verification subsystem, an external verification source, or a combination thereof.

6. The system of claim 1, wherein the event module is further configured to share the data about the event with the at least one other node in the network.

7. The system of claim 6, wherein the at least one other node in the network is configured to independently verify at least one fact in the data about the event.

8. The system of claim 1, wherein the consensus quorum comprises each of the plurality of nodes.

9. The system of claim 1, wherein the consensus quorum comprises a majority of the plurality of nodes.

10. The system of claim 1, wherein the ledger module is further configured to re-queue the event when no consensus quorum has determined the greatest common set.

11. The system of claim 1, wherein the ledger module is further configured to re-queue the event when the local hash and the additional hash disagree.

12. The system of claim 1, wherein the event comprises a rewards point exchange, a rewards point earning, a rewards point payment, a contract creation, a contract rescindment, an investment, an account adjustment, or a combination thereof.

13. The system of claim 1, further comprising a client comprising:
a client processor;
a client memory; and
a client module configured to connect to at least one of the plurality of nodes via the network and submit the data about the event to the at least one node.

14. The system of claim 13, wherein the ledger module is further configured to communicate to the client an indication that the block has been written into the distributed ledger.

15. The system of claim 1, wherein the distributed ledger comprises a blockchain.

16. A method for providing distributed event synchronization, the method comprising:
receiving, with an event module of one of a plurality of nodes in communication with one another via a network, data about an event to be codified in a distributed ledger;
placing, with the event module, the event in an event queue for distributed block negotiation;
performing, with a ledger module of the one of the plurality of nodes, the block negotiation with at least one other node in the network by:
sharing the event queue;
determining a greatest common set of shared events comprising the event;
when a consensus quorum of the plurality of nodes has determined the greatest common set, creating a block comprising the greatest common set of shared events;
generating a local hash of the block;
sharing local data relating to the block;
receiving additional data relating to the block from the at least one other node; and
when the local data and the additional data agree, writing the block into a distributed ledger shared by the memory of each of the plurality of nodes.

17. The method of claim 16, wherein the local data comprises a local hash of the block, the method further comprising generating, with the ledger module, the local hash of the block.

18. The method of claim 16, wherein the additional data comprises at least one additional hash from the at least one other node.

19. The method of claim 16, further comprising verifying, with the event module, at least one fact in the data about the event.

20. The method of claim 19, wherein verifying the at least one fact comprises receiving verification from a verification subsystem, an external verification source, or a combination thereof.

21. The method of claim 16, further comprising sharing, with the event module, the data about the event with the at least one other node in the network.

22. The method of claim 21, further comprising independently verifying, with the at least one other node in the network, at least one fact in the data about the event.

23. The method of claim 16, wherein the consensus quorum comprises each of the plurality of nodes.

24. The method of claim 16, wherein the consensus quorum comprises a majority of the plurality of nodes.

25. The method of claim 16, further comprising re-queueing, with the ledger module, the event when no consensus quorum has determined the greatest common set.

26. The method of claim 16, further comprising re-queueing, with the ledger module, the event when the local hash and the additional hash disagree.

27. The method of claim 16, wherein the event comprises a rewards point exchange, a rewards point earning, a rewards point payment, a contract creation, a contract rescindment, an investment, an account adjustment, or a combination thereof.

28. The method of claim 16, further comprising:
connecting, with a client, to at least one of the plurality of nodes via the network and;
submitting, with the client, the data about the event to the at least one node.

29. The method of claim 28, further comprising communicating, with the ledger module, to the client an indication that the block has been written into the distributed ledger.

30. The method of claim 16, wherein the distributed ledger comprises a blockchain.
